(19) United States
(12) Patent Application Publication
(10) Pub. No.: US 2014/0124308 A1
(43) Pub. Date: May 8, 2014

(54) BRAKE DISK FOR VEHICLE

(71) Applicants: HYUNDAI MOTOR COMPANY, Seoul (KR); KIA MOTORS CORPORATION, Seoul (KR); NAMYANG IND. CO., LTD., Ansan (KR)

(72) Inventors: Yoon Cheol Kim, Suwon (KR); Jae Young Lee, Yongin (KR); Seong Jin Kim, Yongin (KR); Jai Min Han, Ansan (KR); Sung Jong Hong, Seoul (KR); Ki Jeong Kim, Siheung (KR)

(73) Assignees: Hyundai Motor Company, Seoul (KR); Namyang Ind. Co., Ltd., Ansan (KR); Kia Motors Corporation, Seoul (KR)

(21) Appl. No.: 13/717,018

(22) Filed: Dec. 17, 2012

(30) Foreign Application Priority Data
Nov. 6, 2012 (KR) 10-2012-0124754

(51) Int. Cl. F16D 65/12

(52) U.S. Cl. CPC F16D 65/123
USPC 188/218 XL

(57) ABSTRACT

Disclosed herein is a brake disk for a vehicle, including: a hat mounted on a shaft of a wheel and including a plurality of mounting apertures formed in a radial direction along a circumferential lip of the hat; a braking band having a shape enclosing an outer portion of the hat and including a plurality of sliding bores formed in the radial direction at positions corresponding to the plurality of mounting apertures along the circumferential lip of the hat; and a plurality of sliding pins each having one end portion mounted in the mounting aperture and the other end portion fitted into the sliding bore and to slide within the sliding bore in the radial direction.

### CROSS REFERENCE TO RELATED APPLICATION

This application claims the benefit of Korean Patent Application No. 10-2012-0124754, filed on Nov. 6, 2012, entitled “Brake Disk for Vehicle”, which is hereby incorporated by reference in its entirety into this application.

### BACKGROUND OF THE INVENTION

1. Technical Field

The present invention relates to a brake disk for a vehicle, and more particularly, to a brake disk for a vehicle capable of improving fuel efficiency by improving a fastening structure between a hat and a braking band to decrease the weight of the brake disk without decreasing performance of the brake disk.

2. Description of the Related Art

Generally, due to petroleum energy shortage and climate changes, automakers all over the world are developing technologies for improving fuel efficiency. Among the technologies for improving the fuel efficiency is a technology of decreasing the weight of a vehicle without decreasing performance. Particularly, since the technology is efficient in improving the fuel efficiency to decrease weight directly associated with a wheel driving load, research and development for related technologies have been conducted.

FIG. 1 shows a brake disk according to the related art. As shown in FIG. 1, the brake disk according to the related art is configured to include a hat 1 mounted on a hub and a disk shaped disk 2 in which friction is made during braking.

In the brake disk as described above, both the hat 1 and the disk 2 are made of grey cast iron, a material having excellent braking characteristics such as high vibration damping capacity, damping property, heat radiation property, lubricating function, and the like, due to a structure of flake graphite. However, the grey cast iron has specific gravity of about 7.2 g/cm³ and is heavy, thereby decreasing the fuel efficiency.

The features described as the related art have been provided only for assisting in the understanding for the background of the present invention and should not be considered as corresponding to the related art known to those skilled in the art.

[NOTE: Please add the above references to the Information Disclosure Statement.]

### SUMMARY OF THE INVENTION

The present invention provides a brake disk for a vehicle capable of improving fuel efficiency by improving a fastening structure between a hat and a braking band (disk or rotor) reducing the weight of the brake disk without decreasing performance of the brake disk.

According to an exemplary embodiment of the present invention, a brake disk for a vehicle, includes: a hat mounted at a shaft of a wheel and includes mounting apertures formed in a radial direction along a circumferential lip; a braking band having a shape enclosing an outer portion of the hat and having sliding bores formed in the radial direction at positions corresponding to the mounting apertures along the circumferential lip; and sliding pins each having one end portion mounted in the mounting aperture and the other end portion fitted into the sliding bore wherein the sliding pins slide within the sliding bore in the radial direction.

An extension part may be formed on a circumference surface of the hat to be bent in an axial direction and the mounting aperture may be formed in the extension part, a fitting part may be formed at the center of one end portion of the sliding pin and may be fitted into one end portion side of the mounting aperture, a step part may be formed on an outer circumference surface of the fitting part and may be supported by the extension part positioned on a circumference surface of the mounting aperture, and a bolt may be bolted to the other end portion side of the mounting aperture based on the fitting part, to couple the sliding pin to the extension part. The hat may include a plurality of protrusions extending from the edges of the hat in a semi-trapezoid shape, on which the mounting apertures are formed. Furthermore, the apertures may include a recessed portion on an inner surface/lip of the hat, on each protrusion.

The other end portion of the sliding pin may have a shape corresponding to the sliding bore, and the other end portion of the sliding pin may have the same cross sectional area in a length direction as the sliding bore.

When inserting the other end portion of the sliding pin into the sliding bore, only a portion of the other end portion of the sliding pin may be inserted into the sliding bore, and an inner portion of the sliding bore may include a marginal length into which the sliding pin does not enter, wherein the marginal length is longer than a remaining length of the other end portion of the sliding pin that is not inserted into the sliding bore.

Moreover, heat radiation grease may be applied to the sliding bore. An even number of sliding pins may be installed at a uniformly divided angle along the circumference surface/lip of the hat which may be made of a lightweight thermal conductor.

### BRIEF DESCRIPTION OF THE DRAWINGS

FIG. 1 is an exemplary view showing a brake disk for a vehicle according to the related art;

FIG. 2 is an exemplary view showing a hat and a braking band assembled together according to an exemplary embodiment of the present invention;

FIG. 3 is an exemplary view showing the hat and the braking band before assembly according to the exemplary embodiment of the present invention;

FIG. 4 is an exemplary cross-sectional view taken along the line A-A shown FIG. 2 according to the exemplary embodiment of the present invention; and

FIG. 5 is an exemplary view of a fastened state of a sliding pin according to the exemplary embodiment of the present invention.

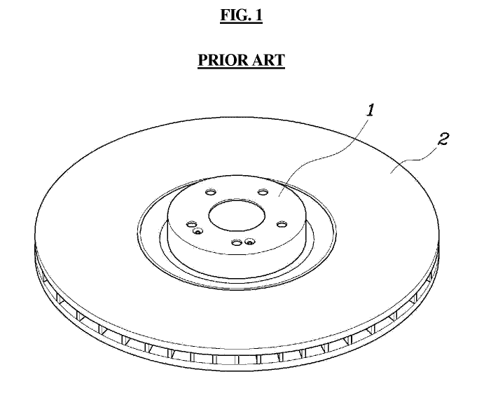

### DESCRIPTION OF THE PREFERRED EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

An exemplary embodiment of the present invention will be described in detail with reference to the accompanying drawings.

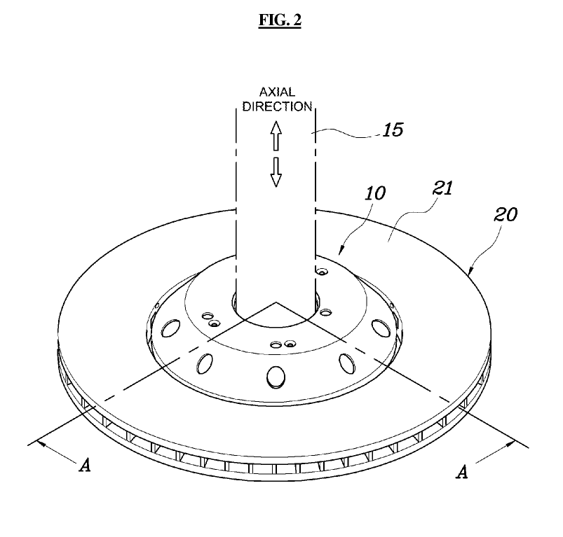

A brake disk for a vehicle according to an exemplary embodiment of the present invention shown in FIGS. 2 to 5 may include a hat 10, a braking band (disk or rotor) 20, and a plurality of sliding pins 30.

More specifically, the brake disk for a vehicle according to the exemplary embodiment of the present invention may include a hat 10 mounted at on shaft 15 of a wheel and including mounting apertures 12 formed in a radial direction along a circumferential lip, the braking band 20 having a shape enclosing an outer portion of the hat 10 and including sliding apertures 22 formed in the radial direction at positions corresponding to the mounting apertures 12 along the circumferential lip/surface, and the sliding pins 30 each having one end portion mounted in the mounting aperture 12 and the other end portion fitted into the sliding bore 22 and mounted to be slidable within the sliding bore 22 in the radial direction. The hat 10 may include a plurality of protrusions extending from the edges of the hat in a semi-trapezoid shape, on which the mounting apertures 12 are formed. Furthermore, the apertures 12 may include a recessed portion on an inner surface/lip of the hat 10, on each protrusion.

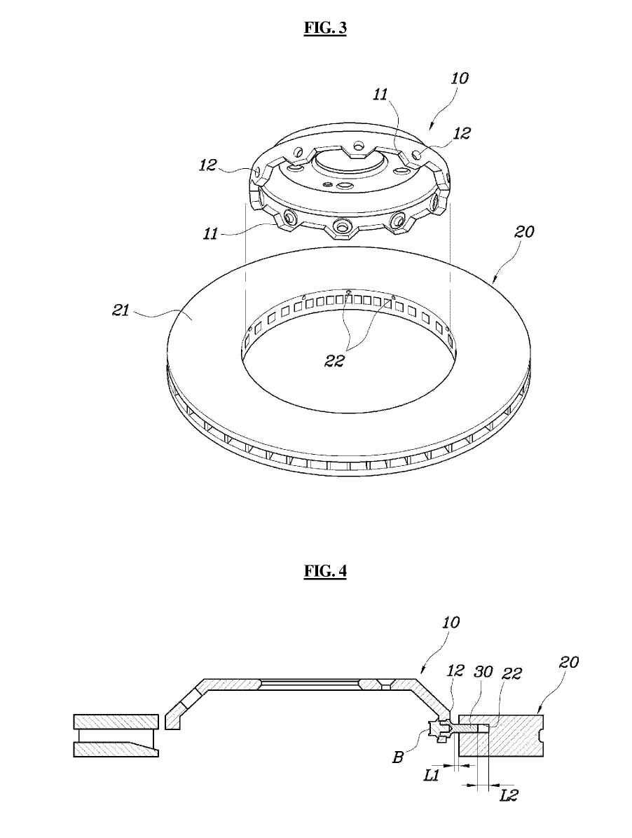

FIG. 2 is an exemplary view showing a hat 10 and a braking band 20 assembled together; and FIG. 3 is an exemplary view showing the hat 10 and the braking band 20 prior to assembly.

Referring to FIGS. 2 and 3, the hat 10, having a center mounted on the shaft 15 of the to wheel, at a hub, may include a plurality of mounting apertures 12 radially formed along an outer circumference surface/lip.

The mounting apertures 12 may be formed in the radial direction of the hat 10, to couple the plurality of sliding pins 30 to the mounting apertures 12 in the radial direction. In addition, the mounting apertures 12 and sliding bores 22 to be described below may be formed on a concentric circle. The hat 10 may be made of a lightweight thermal conductor, such as, aluminum. Therefore, weight of the hat 10 may be decreased, thereby improving fuel efficiency.

The braking band 20, assembled to the hat 10, may include a friction surface 21 formed along an outer circumference surface thereof. The braking band 20 may have a disk shape and be manufactured and molded by casting grey cast iron. In addition, the braking band 20 may be a solid braking band including a single disk or may be a ventilated braking band having a plurality of ribs connected between two disks. Cooling performance may be improved using the ventilated braking band 20.

Further, a plurality of sliding bores 22 may be formed at positions corresponding to the mounting apertures 12 along an inner circumference of the friction surface 21 and may be spaced at substantially equal intervals along the inner circumference of the braking band 20. The sliding bore 22 may be formed in the radial direction of the braking band 20, to allow movement of the sliding pin 30 within the sliding bore 22 in the radial direction of the braking band 20. In particular, the sliding bore 22 may have an inner diameter corresponding to an outer diameter of the other end portion of the sliding pin 30 to guide and move the sliding pin 30 along the sliding bore 22.

The sliding pin 30 may have one end portion fitted into the mounting aperture 12 and the other end portion fitted into the sliding bore 22. Further, the sliding bore 22 may be formed in the radial direction of the braking band 20, to slid the other end portion of the sliding pin 30 within the sliding bore 22 in the radial direction, as described above.

In other words, during vehicle braking, high heat is generated in the braking band 20 and the braking band 20 may be fixed to the sliding pin 30, concentrating stress according to thermal expansion of the braking band 20 on the sliding pin 30. Therefore, the sliding pin 30 may be installed to move in the sliding bore 22 formed in the braking band 20 in the radial direction.

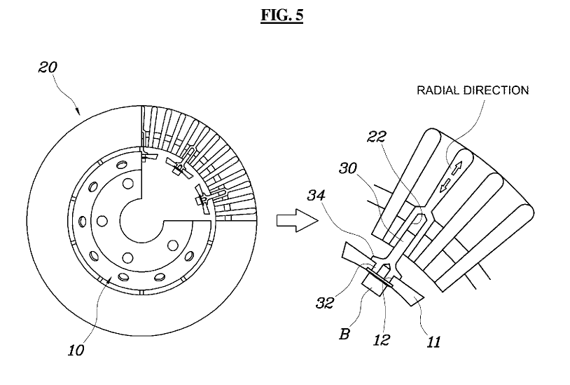

FIG. 4 is an exemplary cross-sectional view taken along the line A-A shown FIG. 2; and FIG. 5 is an exemplary view of a fastened state of a sliding pin 30 according to the exemplary embodiment of the present invention.

A coupled structure of the sliding pin 30 will be described with reference to FIGS. 4 and 5. An extension part 11 may be formed on a circumference of the hat 10 to be bend in an axial direction and the mounting aperture 12 may be formed in the extension part 11, a fitting part 32 may be formed at the center of one end portion of the sliding pin 30 and may be fitted into one end portion side of the mounting aperture 12, a step part 34 may be formed on an outer circumference surface of the fitting part 32 and may be supported by the extension part 11 positioned at a circumference of the mounting aperture 12, and a bolt B is bolted to the other end portion side of the mounting aperture 12 based on the fitting part 32, to couple the sliding pin 30 to the extension part 11.

In other words, the extension part 11 may be formed to be bent along an edge of the hat 10, and the mounting aperture 12 may be formed in the extension part 11, in the radial direction of the hat 10. Therefore, the fitting part 32 formed at one end portion of the sliding pin 30 may be fitted into the mounting aperture 12, and the bolt B may be bolted to the center of the fitting part 32, so one end portion of the sliding pin 30 may be fastened to the hat 10. As a result, the sliding pin 30 may be fastened to the braking band 20 in the radial direction of the braking band 20.

In addition, as shown in FIGS. 4 and 5, the other end portion of the sliding pin 30 may have a shape corresponding to the sliding bore 22, and the other end portion of the sliding pin 30 and the sliding bore 22 may have the same cross sectional area in a length direction. In other words, a cross sectional area of an inner diameter of the sliding bore 22 may be formed in the length direction, and a cross sectional area of an outer diameter of the other end portion of the sliding pin 30 fitted into the sliding bore 22 may be formed in the length direction, to allow the other end portion of the sliding pin 30 to slid within the sliding bore 22.

Moreover, the other end portion of the sliding pin 30 may be formed to have a tolerance rang of about 0.005 to 0.03 mm, and one end portion of the sliding pin 30 may be formed to have a tolerance range of about 0.005 to 0.03 mm, providing a clearance fit.

In addition, when inserting the other end portion of the sliding pin 30 into the sliding bore 22, only a portion of the other end portion of the sliding pin 30 may be inserted into the sliding bore 22, and an inner portion of the sliding bore 22 includes a marginal length L2 into which the sliding pin 30 does not enter, wherein the marginal length L2 may be longer than a remaining length L1 of the other end portion of the sliding pin 30 that is not inserted into the sliding bore 22.

In other words, since the sliding pin 30 may be slid into the sliding bore during thermal expansion of the braking band 20 while the vehicle is braking , a marginal space may be provided in the sliding bore 22, thereby preventing concentration of stress due to contact between an end portion of the sliding pin 30 and an inner portion end of the sliding bore 22 when the sliding pin 30 is moved within the sliding bore 22.

In addition, heat radiation grease may be applied to the sliding bore 22 to rapidly transfer the heat generated in the braking bank 20 to the hat 10 having high thermal conductivity to lower a temperature of the braking band 20.

Referring to FIG. 5, an even number of sliding pins 30 may be installed at a uniformly divided angle along the circumference of the hat 10 (e.g., a lip). In other words, the even number of sliding pins 30 (e.g., ten sliding pins, twelve sliding pins, fourteen sliding pins, sixteen sliding pins, or the like) may be installed in substantially equal intervals along the circumference surface/lip of the hat 10. The even number of sliding pins 30 may be disposed, providing structural symmetry along the circumference surface, thereby securing a braking torque and robustness against road surface vibration.

According to the exemplary embodiment of the present invention as described above, the hat is made of a lightweight material, and the lightweight hat and the braking band are assembled together using a sliding movement structure by the sliding pin to decrease weight of the brake disk, thereby making it possible to improve fuel efficiency.

Meanwhile, although specific examples of the present invention have been described above in detail, it is obvious to those skilled in the art that various modifications and alterations may be made without departing from the spirit and scope of the present invention. In addition, it is obvious that these modifications and alterations are within the following claims.

What is claimed is:

1. A brake disk for a vehicle, comprising:
a hat mounted on a shaft of a wheel and including a plurality of mounting apertures formed in a radial direction along a circumferential lip of the hat;
a braking band having a shape enclosing an outer portion of the hat and including a plurality of sliding apertures formed in a radial direction at positions corresponding to the plurality of mounting apertures along the circumferential lip of the hat; and
a plurality of sliding pins each having one end portion mounted in each mounting aperture and an other end portion fitted into each sliding aperture to slide within each sliding aperture in the radial direction.

2. The brake disk for a vehicle of claim 1, further comprising:
an extension part formed on a circumference surface of the hat bent in an axial direction, wherein the plurality of mounting apertures are formed in the extension part;
a fitting part formed at a center of one end portion of each sliding pin and fitted into one end portion side of each mounting aperture;
a step part formed on an outer circumference surface of the fitting part and supported by the extension part; and
a bolt bolted to the other end portion side of the mounting aperture based on the fitting part, to couple the sliding pin to the extension part.

3. The brake disk for a vehicle of claim 1, wherein the other end portion of each sliding pin has a shape corresponding to each sliding bore, and has a same cross sectional area as each sliding bore.

4. The brake disk for a vehicle of claim 1, wherein only a portion of another end portion of the sliding pin is inserted into the sliding bore, and an inner portion of the sliding bore includes a marginal length into which the sliding pin does not enter, wherein the marginal length is longer than a remaining length of the other end portion of the sliding pin that is not inserted into the sliding bore.

5. The brake disk for a vehicle of claim 1, wherein heat radiation grease is applied to the sliding bore.

6. The brake disk for a vehicle of claim 1, wherein an even number of sliding pins are installed at a uniformly divided angle along the circumference lip of the hat.

7. The brake disk for a vehicle of claim 1, wherein the hat is made of a lightweight thermal conductor.

8. A hat for a brake disk of a vehicle, comprising:
a plurality of mounting apertures formed in a radial direction along an outer circumferential lip of the hat corresponding to a plurality of sliding apertures formed in a radial direction of a braking band at positions corresponding to the plurality of mounting apertures along an inner circumferential surface, wherein a plurality of sliding pins each having one end portion mounted in each mounting aperture and an other end portion fitted into each sliding aperture to slide within each sliding aperture in the radial direction.

9. The hat of claim 8, further comprising:
an extension part formed on the circumference surface of the hat bent in an axial direction, wherein the plurality of mounting apertures are formed in the extension part;
a fitting part formed at a center of one end portion of each sliding pin and fitted into one end portion side of each mounting aperture;
a step part formed on an outer circumference surface of the fitting part and supported by the extension part; and
a bolt bolted to the other end portion side of the mounting aperture based on the fitting part, to couple the sliding pin to the extension part.

10. The hat of claim 8, wherein the other end portion of each sliding pin has a shape corresponding to each sliding bore, and has same cross sectional as each sliding bore.

11. The hat of claim 8, wherein only a portion of the other end portion of the sliding pin is inserted into the sliding bore.

12. The brake disk for a vehicle of claim 8, wherein an even number of sliding pins are installed at a uniformly divided angle along the circumference surface of the hat.

13. The brake disk for a vehicle of claim 8, wherein the hat is made of a lightweight thermal conductor.
